(19) United States
(12) Patent Application Publication
(10) Pub. No.: US 2026/0173225 A1
(43) Pub. Date: Jun. 18, 2026

(54) INDUCTION HEATING DEVICE AND METHOD FOR OPERATING SAME

(71) Applicant: Samsung Electronics Co., Ltd., Suwon-si (KR)

(72) Inventors: Hongjoo KANG, Suwon-si (KR); Eundae BAE, Suwon-si (KR); Myoungjin HAM, Suwon-si (KR)

(21) Appl. No.: 19/535,663

(22) Filed: Feb. 10, 2026

Related U.S. Application Data
(63) Continuation of application No. PCT/KR2024/007712, filed on Jun. 5, 2024.

(30) Foreign Application Priority Data
Aug. 10, 2023 (KR) 10-2023-0104598

(51) Int. Cl. H05B 6/06; H05B 6/04; H05B 6/12

(52) U.S. Cl. CPC H05B 6/062; H05B 6/04; H05B 6/1245; H05B 2213/05

(57) ABSTRACT

An induction heating device is provided. The induction heating device includes a display, a power supply circuit configured to supply power, a first heating circuit including a first working coil configured to generate a magnetic field in response to a current flow caused by power supply of the power supply circuit, a first sensing circuit including a first resonant capacitor connected in parallel with the first working coil to form a resonant circuit, and configured to output a first container recognition signal using a resonant signal generated by the resonant circuit and a reference voltage value, a first relay circuit configured to selectively operate in one of a first connection state in which the first working coil and the first resonant capacitor are connected in parallel, or a second connection state in which a current flow caused by the power supply of the power supply circuit is formed in the first working coil, and a controller configured to recognize that a container is placed on the first working coil by the first container recognition signal, and control the display to display a message indicating that the container is placed on the first working coil.

### CROSS-REFERENCE TO RELATED APPLICATION(S)

This application is a continuation application, claiming priority under 35 U.S.C. § 365(c), of an International application No. PCT/KR2024/007712, filed on Jun. 5, 2024, which is based on and claims the benefit of a Korean patent application number 10-2023-0104598, filed on Aug. 10, 2023, in the Ministry of Intellectual Property (MOIP), the disclosure of which is incorporated by reference herein in its entirety.

### BACKGROUND

### 1. Field

The disclosure relates to an induction heating device capable of recognizing a container and a method for operating the same.

### 2. Description of Related Art

Heating devices, which are cooking appliances used for cooking, may be classified into gas ranges or electric ranges according to the heat source that generates heat (e.g., gas or electricity). The electric range may use electricity to generate an electromagnetic field, a high-frequency wave (or a microwave), radiant heat, or convection heat. The electric range may be classified into a hot plate type, a highlight type, and an induction heating type depending upon its heating element.

The hot plate type or the highlight type of electric range uses a method of directly heating a top plate on which a cooking container is placed. The induction heating type of electric range adopts a method of heating a cooking container with an electromagnetic field by flowing a high-frequency current through a coil contained therein, rather than a method of directly transferring heat to the cooking container. Such an electric range based on the induction heating type is referred to as an ‘induction range’ or an ‘induction heating device’. In the induction heating device, a cooking container whose bottom or entire body is made of a magnetic material may be used, but a cooking container made of some non-magnetic materials, such as 400-series stainless steel, may also be used.

The induction heating device may operate only in case that the cooking container is placed at a designated position. Therefore, for normal operation, the induction heating device should be able to recognize whether a usable cooking container is placed at a predetermined position (e.g., a position where a cooking coil is installed).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an induction heating device capable of recognizing a container and a method for operating the same.

Additional aspects will be set forth in part in the description which follows and, in part, will be apparent from the description, or may be learned by practice of the presented embodiments.

In accordance with an aspect of the disclosure, an induction heating device is provided. The induction heating device includes a display, a power supply circuit for supplying power, a first heating circuit including a first working coil configured to generate a magnetic field in response to a current flow by power supply of the power supply circuit, a first sensing circuit including a first resonant capacitor connected in parallel with the first working coil to form a resonant circuit, and configured to output a first container recognition signal using a resonant signal generated by the resonant circuit and a reference voltage value, a first relay circuit configured to selectively operate in one of a first connection state in which the working coil and the resonant capacitor are connected in parallel, or a second connection state in which a current flow caused by the power supply of the power supply circuit is formed through the working coil, and a controller configured to recognize that a container is placed on the working coil by the container recognition signal, and control the display to indicate a message informing that the container is placed on a first working coil.

In accordance with another aspect of the disclosure, a container recognition circuit included in the induction heating device is provided. The container recognition circuit includes a resonant capacitor, a working coil generating a magnetic field by power supplied, and a relay unit operating to connect the working coil and the resonant capacitor in parallel until a container heating event occurs, and a terminal for supplying an auxiliary power source is provided at any point of the resonant circuit that is configured by a limited parallel connection of the working coil and the resonant capacitor.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of use of an induction heating device according to an embodiment of the disclosure;

FIG. 2 is a block diagram of an induction heating device according to an embodiment of the disclosure;

FIG. 3 illustrates a driving circuit of an induction heating device according to an embodiment of the disclosure;

FIG. 4 illustrates a control flow of performing a heating operation based on container recognition in an induction heating device according to an embodiment of the disclosure;

FIG. 5 illustrates a path activated during a container recognition operation in a driving circuit of an induction heating device according to an embodiment of the disclosure;

FIG. 6 illustrates a path activated during a container heating operation in a driving circuit of an induction heating device according to an embodiment of the disclosure;

FIG. 7 illustrates a signal timing for container recognition in an induction heating device according to an embodiment of the disclosure; and

FIG. 8 illustrates a driving circuit in an induction heating device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to various embodiments of the disclosure, an induction heating device capable of selectively performing a container recognition function and a container heating function using a relay, and an operating method thereof, may be provided.

According to an embodiment of the disclosure, the induction heating device capable of container recognition may not only reduce the power consumption but also improve the performance of recognizing a container placed in a heating area, by enabling recognition that the container is placed in the heating area simply through a path control using a relay.

The technical problems to be addressed in the disclosure are not limited to those mentioned above, and other technical problems not mentioned above may be derived from the example embodiments of the disclosure by a person having ordinary skill in the art.

The effects that can be obtained from example embodiments of the disclosure may be clearly derived and understood by those having ordinary knowledge in the technical field to which the example embodiments of the disclosure belong from the following description. In other words, any unintended effects of implementing the example embodiments of the disclosure may also be derived by those of ordinary knowledge in the art from the example embodiments of the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

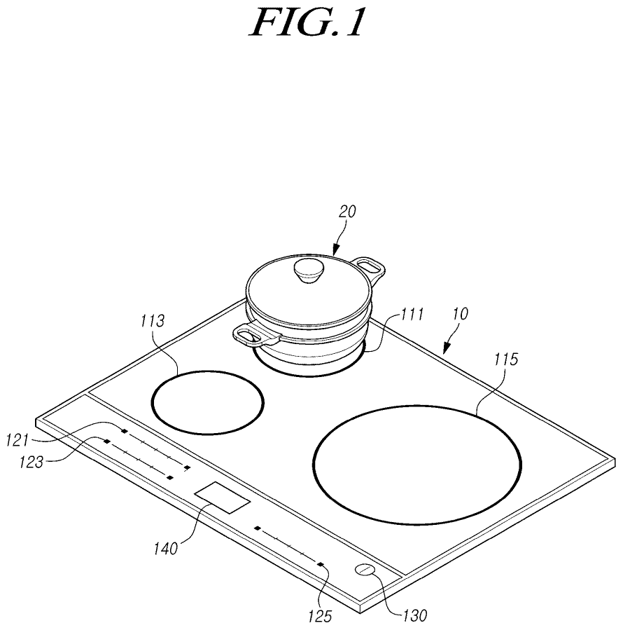

FIG. 1 illustrates an example of use of an induction heating device according to an embodiment of the disclosure.

Referring to FIG. 1, the induction heating device 10 may include one or more heating areas 111, 113 and 115 or an operation unit. The one or more heating areas 111, 113 and 115 may be heating zones for heating a container 20 placed thereon. The operation unit may be provided to control the operation of the induction heating device 10 or to display operational status information. The operation unit may be adapted to allow a combination of various operation buttons according to the function of the induction heating device 10. For example, the operation unit may include a power button 130 for power supply, temperature control buttons 121, 123 and 125 for controlling the temperature of each heating area 111, 113 or 115, or a display 140. These buttons included in the operation unit may support an operation scheme of enabling touch manipulation. The power button 130 may control supply of operating power to the induction heating device 10. The temperature control buttons 121, 123 and 125 may adjust the output of the corresponding heating area 111, 113 and 115 to predetermined levels. The display 140 may represent operational status information of the induction heating device 10. The display 140 may show information (e.g., the location of the heating area where a container is placed) indicating on which heating area 111, 113 or 115 a container (e.g., a cooking container 20) is placed set upon. The display 140 may display information about an output level of the heating area 111, 113 or 115 in use.

On the one or more heating areas 111, 113 and 115 may be placed or set a container (e.g., the cooking container 20) for heating. The one or more heating areas 111, 113 and 115 may include a large-sized heating zone, a medium-sized heating zone, or a small-sized heating zone. The large-sized heating zone, medium-sized heating zone, or small-sized heating zone may be classified based on the maximum output (e.g., 1,200 W, 1,500 W, 2,000 W, 2500 W, or 3,000 W).

The induction heating device 10 may perform a container recognition operation for sensing that the container 20 is placed or set on the one or more heating areas 111, 113 and/or 115.

The induction heating device 10, in case that an event initiating power supply occurs (hereinafter, referred to as a ‘power supply initiation event’), may perform a primary container recognition operation in response thereto. The power supply initiation event may occur by turning on the power of the induction heating device 10. For example, the induction heating device 10 may recognize that the power is turned on by a power plug being inserted into a power outlet. For example, the induction heating device 10 may recognize that the power is turned on by the power button 130 included in the operation unit being turned on while the power plug is inserted into the power outlet.

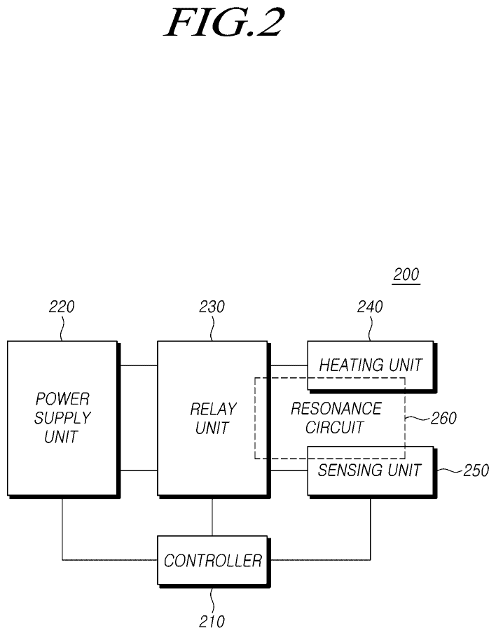

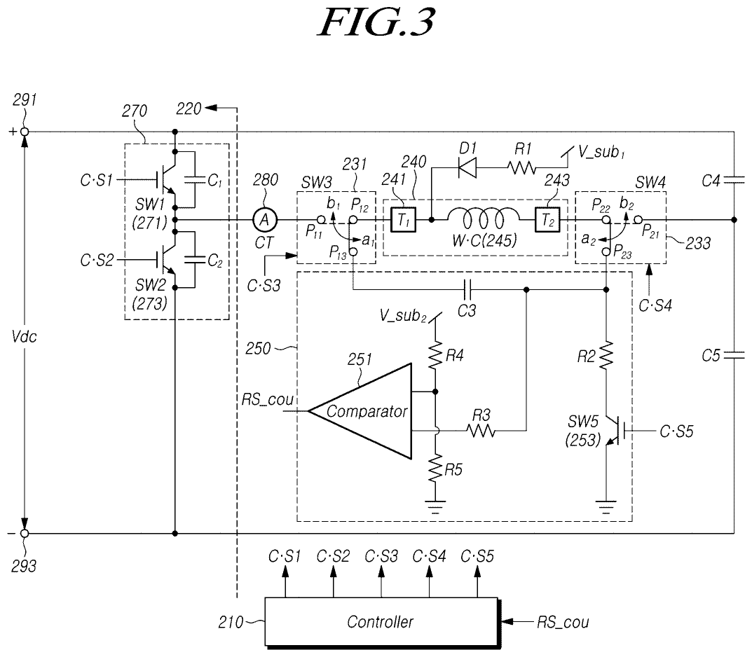

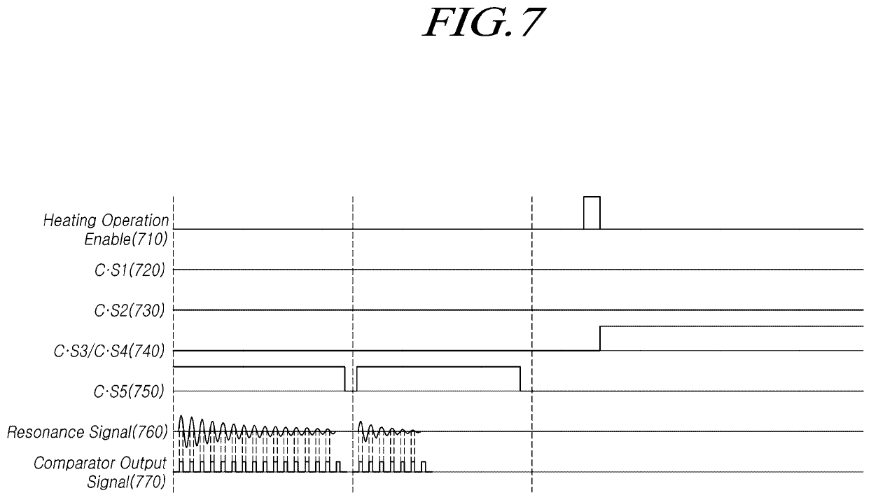

The primary container recognition operation may be a container recognition operation in a state where power is not supplied to obtain output from one or more heating areas 111, 113 and/or 115 (hereinafter, referred to as a ‘pre-power supply state’). The induction heating device 10 may display a message on the display 140 informing that the primary container recognition operation is being performed. In the pre-power supply state, the power is not supplied to a working coil (e.g., a working coil (W.C 245) of FIG. 3) for heating the one or more heating areas 111, 113 and/or 115, and a voltage to be used for a heating operation may be charged to a charging capacitor (e.g., C3 and C4 of FIG. 3). During the primary container recognition operation, a resonant circuit (e.g., the resonant circuit 260 of FIG. 2) may be activated. For example, the resonant circuit (e.g., the resonant circuit 260 of FIG. 2) may be formed by an internal relay (e.g., a first relay 231 or a second relay 233 of FIG. 3) in the primary container recognition operation. The resonant circuit (e.g., the resonant circuit 260 of FIG. 2) may generate a resonant signal (e.g., a resonant signal 760 of FIG. 7). To perform the primary container recognition operation, the induction heating device 10 may use the resonant signal 760. The resonant signal 760 may include a sine wave having a predetermined period. The amplitude of the resonant signal 760 may gradually decrease over time. For example, the primary container recognition operation may utilize a difference between a resonant signal generated by the resonant circuit 260 in case that the container 20 is placed on the heating areas 111, 113 and/or 115 (hereinafter, referred to as a ‘first resonant signal’) and a resonant signal generated by the resonant circuit 260 in case that the container 20 is not placed on the heating areas 111, 113 and/or 115 (hereinafter, referred to as a ‘second resonant signal’). For instance, as time elapses, the speed at which the amplitude of the first resonant signal decreases may be relatively faster than the speed at which the amplitude of the second resonant signal decreases. This is because a resistance component due to the container 20 being placed on the heating areas 111, 113 and/or 115 may affect the resonant circuit 260. In case that it is detected that the container 20 is placed on the heating areas 111, 113 and/or 115 in the primary container recognition operation, the induction heating device 10 may display, on the display 140, the location information of the heating area where the container 20 is placed. The induction heating device 10 may display a message on the display 140 informing temperature control for heating the container 20 placed on the heating areas 111, 113 and/or 115. In the drawing, it is assumed that the container 20 is placed on the heating area 111.

The induction heating device 10 may monitor whether an event requesting an output (hereinafter referred to as a ‘container heating event’) occurs, while performing the primary container recognition operation. The container heating event may be generated by manipulation of the temperature control button 121, 123 or 125 corresponding to at least one heating area of the one or more heating areas 111, 113 and/or 115. In case that the container heating event occurs, the induction heating device 10 may perform a secondary container recognition operation in response thereto. The induction heating device 10 may display a message on the display 140 indicating that the container heating event has occurred. The induction heating device 10 may display a message on the display 140 indicating that the secondary container recognition operation is being performed.

The secondary container recognition operation may be a container recognition operation in a state where power supply for heating the one or more heating areas 111, 113 and/or 115 is being performed (hereinafter, referred to as a ‘post-power supply state’). In the post-power supply state, the power may be supplied to the working coil (W.C 245) to obtain the output from the one or more heating areas 111, 113 and/or 115. In this case, a current flow may be created in the working coil (W.C 245) due to the supplied power. The current flow causes the working coil (W.C 245) to generate an electromagnetic field. The electromagnetic field may be used to heat the container 20 placed on the heating areas 111, 113 and/or 115. The induction heating device 10 may display a message, on the display 140, indicating that the electromagnetic field for heating the container 20 is being output from the heating areas 111, 113 and/or 115 where the container 20 is placed. In the drawing, it is assumed that the container 20 is placed on the heating area 111.

In the secondary container recognition operation, the resonant circuit (e.g., the resonant circuit 260 of FIG. 2) that was formed by the internal relay (e.g., the first relay 231 or the second relay 233 of FIG. 3) may be deactivated. Accordingly, the induction heating device 10, during the secondary container recognition operation, may use the amount of current measured by a current transformer (CT) (e.g., a current transformer 280 of FIG. 3) provided on the path where current flows due to the power supply. In the path where current flows, the amount of current measured in the event that the container 20 is placed on the heating areas 111, 113 and/or 115 may be different from the amount of current measured in the event that the container 20 is not placed thereon. For example, the amount of current measured in case that the container 20 is placed may be relatively lower than the amount of current measured in case that the container 20 is not placed. This is because the resistance component due to the container 20 placed on the heating areas 111, 113 and/or 115 may affect the current flow.

The induction heating device 10 may generate an electromagnetic field in the heating areas 111, 113 and/or 115 where the container 20 is placed, in the event of recognizing the container 20 being placed on the heating areas 111, 113 and/or 115 through the primary container recognition operation and then switching to the post-power supply state, or recognizing that the container 20 is placed on the heating areas 111, 113 and/or 115 through the secondary container recognition operation in the post-power supply state. The electromagnetic field may be created by causing a current to flow through the cooking coil 245 arranged corresponding to the respective heating areas 111, 113 and/or 115. The electromagnetic field may be used to heat the container 20 placed on the heating areas 111, 113 and/or 115. In the drawing, it is assumed that the container 20 is placed on the heating area 111.

FIG. 2 is a block diagram illustrating an example induction heating device 200 (e.g., the induction heating device 10 of FIG. 1) according to an embodiment of the disclosure.

Referring to FIG. 2, the induction heating device 200 may include a controller 210, a power supply unit 220 (or power supply circuit 220), a relay unit 230 (or relay circuit 230), a heating unit 240 (or heating circuit 240), and a sensing unit 250 (or sensing circuit 250). Although not shown herein, the induction heating device 200 may further include the operation unit shown in FIG. 1 (e.g., the power button 130, the temperature control buttons 121, 123 and 125, or the display 140 of FIG. 1). The resonant circuit 260 illustrated may be created by parallel connection of a cooking coil (e.g., a cooking coil 245 of FIG. 3) included in the heating unit 240 and a resonant capacitor (e.g., a resonant capacitor C3 of FIG. 3) included in the sensing unit 250, using the relay unit 230. For example, the resonant circuit 260 may be activated in a situation where the induction heating device 200 needs to perform a primary container recognition operation. In such a case, the resonant circuit 260 may be deactivated in a situation where the induction heating device 200 performs a secondary container recognition operation and/or a heating operation.

The power supply unit 220 may supply power for the operation of the induction heating device 200. The power supply unit 220 may include an alternating current (AC) power source and a rectifier. The AC power may be supplied via a power plug inserted into a power outlet. The rectifier may convert the AC power into direct current (DC) power through rectification. The rectifier may generate DC voltages having one or more voltage values necessary for the operation of the induction heating device 200. The rectifier may include, for example, a bridge circuit. According to an example, the power supply unit 220 may include switching elements (e.g., first and second switching elements SW1 (271) and SW2 (273) of FIG. 3) that serially connect terminals (e.g., terminals 291 and 293 of FIG. 3) from which the DC voltage is to be output. The switching elements 271 and 273 may be alternately switched in response to the control by the controller 210 during the heating operation.

The relay unit 230 may selectively connect the heating unit 240 to either the sensing unit 250 or the power supply unit 220. As an example, during the primary container recognition operation, the relay unit 230 may open the connection between the power supply unit 220 and the heating unit 240, and short-circuit the connection between the sensing unit 250 and the heating unit 240. As an example, during the primary container recognition operation, the relay unit 230 may open the connection between the heating unit 240 and the charging unit, and short-circuit the connection between the sensing unit 250 and the heating unit 240. Thereby, the resonant circuit 260 may be established in which the cooking coil 245 and the resonant capacitor C3 are connected in parallel. As an example, during the secondary container recognition operation and/or the container heating operation, the relay unit 230 may open the connection between the sensing unit 250 and the heating unit 240, and short-circuit the connection between the power supply unit 220 and the heating unit 240. As an example, during the secondary container recognition operation and/or the container heating operation, the relay unit 230 may open the connection between the sensing unit 250 and the heating unit 240, and short-circuit the connection between the charging unit and the heating unit 240. Thereby, a current path allowing the current supplied by the power supply unit 220 or the current supplied by the charging unit (e.g., a fourth capacitor C4 or a fifth capacitor C5 of FIG. 3) to flow through the cooking coil 245 may be completed.

The controller 210 may control the power supply unit 220 and/or the relay unit 230 based on the operation state of the induction heating device 10 (e.g., the primary container recognition operation, the secondary container recognition operation, or the container heating operation). The controller 210 may perform the control for the primary container recognition operation based on a container recognition signal provided from the sensing unit 250. The controller 210 may perform the control for the secondary container recognition operation using the amount of current measured by the current transformer 280 included in the heating unit 240. According to an example, the controller 210 may perform control to generate an electromagnetic field in the heating areas 111, 113 and/or 115 where the container 20 is placed, in case that the placement of the container 20 on the heating area (e.g., one or more heating areas 111, 113 and/or 115 of FIG. 1) is recognized by the primary or secondary container recognition operation, and a power supply request event occurs.

FIG. 3 illustrates a driving circuit in an induction heating device (e.g., the induction heating device 10 of FIG. 1) according to an embodiment of the disclosure, and FIG. 7 illustrates signal timing for container recognition in the induction heating device according to an embodiment of the disclosure.

Referring to FIG. 3 or 7, the driving circuit included in the induction heating device 10 may include a controller (e.g., the controller 210 of FIG. 2), a power supply switch unit 270, a relay unit (e.g., the relay unit 230 of FIG. 2), a heating unit (e.g., the heating unit 240 of FIG. 2), a sensing unit (e.g., the sensing unit 250 of FIG. 2), or a charging unit (e.g., the fourth capacitor C4 or the fifth capacitor C5). The power supply switch unit 270 may include a power supply switch circuit. The relay unit (e.g., the relay unit 230 of FIG. 2) may include one or more relay circuits. The heating unit (e.g., the heating unit 240 of FIG. 2) may include one or more heating circuits. The sensing unit (e.g., the sensing unit 250 of FIG. 2) may include one or more sensing circuits. The charging unit (e.g., the fourth capacitor C4 or the fifth capacitor C5) may include one or more charging capacitors.

The power supply switch unit 270 may block a current flow to the heating unit 240 caused by the power supplied by the power supply unit (the power supply unit 220 of FIG. 2), in case that it is in the pre-power supply state for performing the primary container recognition operation. In case that it is in the post-power supply state for performing the secondary container recognition operation and/or the heating operation, the power supply switch unit 270 may provide the current flow to the heating unit 240 caused by the power supplied by the power supply unit (the power supply unit 220 of FIG. 2).

According to an example, the power supply switch unit 270 may include switching elements (e.g., the first and second switching elements SW1 (271) and SW2 (273) of FIG. 3) that serially connect the terminals 291 and 293 from which the DC voltage is to be output. The first and second switching elements SW1 (271) and SW2 (273) may be transistors. The first switching element SW1 (271) may be switched by the first switching control signal (C.S1) provided from the controller 210 (C.S1 (720) of FIG. 7). The second switching element SW2 (273) may be switched by the second switching control signal (C.S2) provided from the controller 210 (C.S2 (730) of FIG. 7).

During the primary container recognition operation, the first and second switching elements SW1 (271) and SW2 (273) may be turned off by the first switching control signal (C.S1) provided from the controller 210. In this case, the power supplied from the power supply unit 220 may charge the charging unit (e.g., the fourth capacitor C4 or the fifth capacitor C5).

During the secondary container recognition operation and/or the heating operation, the first and second switching elements SW1 (271) and SW2 (273) may be alternately switched in response to the first switching control signal (C.S1) provided from the controller 210. The alternating switching operation of the first and second switching elements SW1 (271) and SW2 (273) may periodically change the current supply path to the heating unit 240. As an example, in case where the first switch SW1 (271) is turned on and the second switch SW2 (273) is turned off, a current path corresponding to the current flow caused by the power supplied from the power supply unit 220 may be established. As an example, in case where the first switch SW1 (271) is turned off and the second switch SW2 (273) is turned on, a current path corresponding to the current flow caused by the voltage supplied from the charging unit (e.g., the fourth capacitor C4 or the fifth capacitor C5) may be established.

According to an example, N-type Field-Effect Transistors (FETs) may be used for the first and second switching elements SW1 (271) and SW2 (273). The drain terminal of the first FET used as the first switch SW1 (271) may be connected to the terminal (+) to which power is supplied from the power supply unit 220. The first switching control signal (C.S1) provided by the controller 210 is input to the gate terminal of the first FET. The source terminal of the first FET may be connected to the drain terminal of the second FET used as the second switch SW2 (273). A first capacitor C1 may be connected across the drain terminal and the source terminal of the first FET. The drain terminal of the second FET used as the second switch SW2 (273) may be connected to the source terminal of the first FET. The second switching control signal (C.S2) provided by the controller 210 is input to the gate terminal of the second FET. The source terminal of the second FET may be connected to the terminal (−) to which power is supplied from the power supply unit 220. A second capacitor C2 may be connected across the drain terminal and the source terminal of the second FET.

The relay unit 230 may include a first relay 231 or a second relay 233. The first relay 231 may be provided on one side of the heating unit 240, and the second relay 233 may be provided on the other side of the heating unit 240. A current transformer (CT) 280 may be provided between the first relay 231 and the power supply switch unit 270. The current transformer 280 may measure an amount of current flowing between the power supply switch unit 270 and the heating unit 240. The amount of current measured by the current transformer 280 may be transferred to the controller 210. The controller 210, during the secondary container recognition operation, may recognize that a container (e.g., the container 20 of FIG. 1) is placed on a heating area (e.g., the first heating area 111 or the second heating area 113 of FIG. 1) based on a change in the amount of current measured by the current transformer 280.

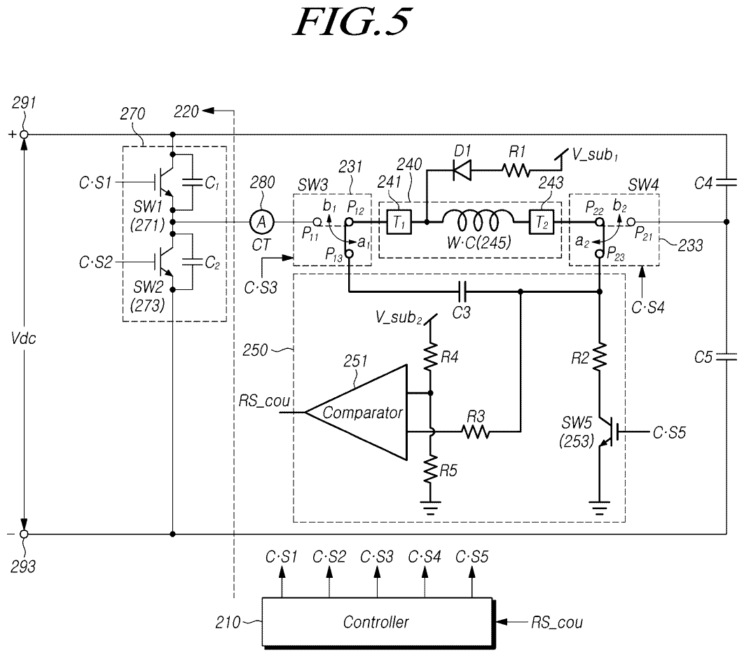

In a normal state, the first relay 231 may open the connection between the power supply unit 220 and the heating unit 240, and short-circuit the connection between the sensing unit 250 and the heating unit 240. It may be referred to as a ‘first connection state’ (refer to FIG. 5). In order for the first relay 231 to be in the normal state, the control of the controller 210 may not be intervened. That is, in the absence of intervention by the controller 210, the first relay 231 may maintain the normal state. The absence of intervention by the controller 210 may be a state where a third switching control signal (C.S3) is not input from the controller 210 (refer to C.S3 (740) of FIG. 7). In such a case, the resonant circuit 260, where the cooking coil 245 included in the heating unit 240 and the resonant capacitor C3 included in the sensing unit 250 are connected in parallel, may be formed. The first connection state may be maintained to perform the primary container recognition operation.

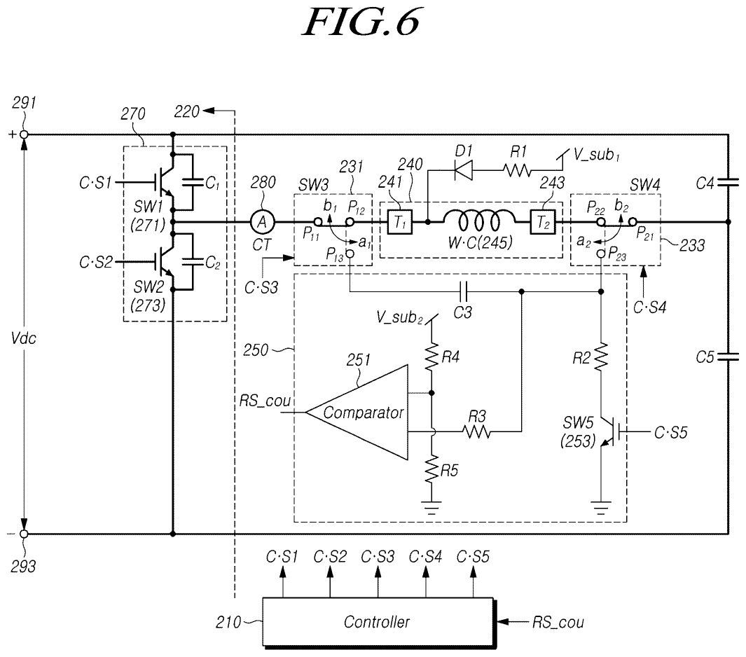

The first relay 231, in its driving state, may open the connection between the sensing unit 250 and the heating unit 240, and short-circuit the connection between the power supply unit 220 and the heating unit 240. It may be referred to as a ‘second connection state’ (refer to FIG. 6). In this case, the resonant circuit 260, where the cooking coil 245 included in the heating unit 240 and the resonant capacitor C3 included in the sensing unit 250 are connected in parallel, may be deactivated. The second connection state may be maintained to perform the secondary container recognition operation and/or the heating operation.

The first relay 231 may be a C-contact relay element including one movable contact P12 and two fixed contacts P11 and P13. The movable contact P12 may be connected to the heating unit 240. One (e.g., P11) of the two fixed contacts P11 and P13 may be connected to the power supply switch unit 270. For example, one (e.g., P11) of the two fixed contacts P11 and P13 may be connected between the first and second switching elements SW1 (271) and SW2 (273) making up the power supply switch unit 270. That is, it may be connected between the source terminal of the first FET and the drain terminal of the second FET. One (e.g., P13) of the two fixed contacts P11 and P13 may be connected to the resonant capacitor C3 included in the sensing unit 250.

The second relay 233, in its normal state, may open the connection between the heating unit 240 and the charging unit, and short-circuit the connection between the sensing unit 250 and the heating unit 240. It may be referred to as a ‘first connection state’ (refer to FIG. 5). For the second relay 233 to be in the normal state, the control of the controller 210 may not be intervened. That is, in the absence of intervention by the controller 210, the second relay 233 may maintain the normal state. The absence of intervention by the controller 210 may be a state where a fourth switching control signal (C.S4) is not input from the controller 210 (refer to C.S4 (740) of FIG. 7). In such a case, the resonant circuit 260, where the cooking coil 245 included in the heating unit 240 and the resonant capacitor C3 included in the sensing unit 250 are connected in parallel, may be established. The first connection state may be maintained to perform the primary container recognition operation.

The second relay 233, in the driving state, may open the connection between the sensing unit 250 and the heating unit 240, and short-circuit the connection between the charging unit and the heating unit 240. It may be referred to as a ‘second connection state’ (refer to FIG. 6). In this case, the resonant circuit 260, where the cooking coil 245 included in the heating unit 240 and the resonant capacitor C3 included in the sensing unit 250 are connected in parallel, may be deactivated. The second connection state may be maintained to perform the secondary container recognition operation and/or the heating operation.

The second relay 233 may be a C-contact relay element including one movable contact P22 and two fixed contacts P21 and P23. The movable contact P22 may be connected to the heating unit 240. One (e.g., P21) of the two fixed contacts P21 and P23 may be connected to the charging unit (e.g., the fourth capacitor C4 or the fifth capacitor C5). For example, one (e.g., P21) of the two fixed contacts P21 and P23 may be connected between the fourth capacitor C4 and the fifth capacitor C5 making up the charging unit. One (e.g., P23) of the two fixed contacts P21 and P23 may be connected to the resonant capacitor C3 included in the sensing unit 250.

The heating unit 240 may have a structure in which a cooking coil (W.C 245) is connected between a first terminal T1 (241) and a second terminal T2 (243). The cooking coil 245 may generate an electromagnetic field by a current flowing from the first terminal T1 (241) toward the second terminal T2 (243) (e.g., a current supplied from the power supply unit 220) or a current flowing from the second terminal T2 (243) toward the first terminal T1 (241) (e.g., a current supplied by the fourth and/or fifth capacitor). The electromagnetic field generated by the cooking coil 245 may be used to heat the container 20 placed on the heating area (e.g., one or more heating areas 111, 113 and/or 115 of FIG. 1).

A terminal to which an auxiliary voltage (V_sub1) is supplied may be provided between the first terminal T1 (241) included in the heating unit 240 and the cooking coil 245. The auxiliary voltage (V_sub1) may be applied to the terminal through a resistor R1 and a diode D1. The auxiliary voltage (V_sub1) applied to the terminal may be used for generation of a resonant signal by the resonant circuit 260.

The sensing unit 250 includes a resonant capacitor C3 connecting one fixed contact P13 included in the first relay 231 and one fixed contact P23 included in the second relay 233. In case that the first relay 231 and the second relay 233 are in the normal state, the resonant capacitor C3 may be connected in parallel with the cooking coil 245 included in the heating unit 240 to form the resonant circuit 260. The operation of the resonant circuit 260 may be controlled by a fifth switch element SW5 (253). The fifth switch element SW5 (253) may perform a switching operation by the fifth switch control signal (C.S5) provided from the controller 210 (refer to C.S5 (750) of FIG. 7). An N-type FET may be used for the fifth switch element SW5 (253). The drain terminal of the FET used as the fifth switch SW5 (253) may be connected to the fixed contact P23 of the second relay 233 via a resistor R2. The fifth switching control signal (C.S5) provided by the controller 210 is input to the gate terminal of the FET. The source terminal of the fifth FET may be connected to a ground terminal. In case where the fifth switch SW5 (253) is in the turn-off state, the resonant circuit 260 may generate a resonant signal (refer to the resonant signal 760 of FIG. 7). The resonant circuit 260, in case where the fifth switch SW5 (253) is in the turn-on state, may stop generating the resonant signal (refer to the resonant signal 760 of FIG. 7).

The sensing unit 250 may include a comparator 251. The comparator 251 takes a reference voltage as a first input and the resonant signal generated by the resonant circuit 260 as a second input. For example, in case that a voltage divider is established by two resistors R4 and R5 connected in series between a terminal supplied with the auxiliary voltage (V_sub2) and the ground terminal, the reference voltage may be a voltage divided across the resistor R5 arranged between a first input terminal of the comparator 251 and the ground. The resonant signal generated by the resonant circuit 260 may be applied to a second input terminal of the comparator 251 through a resistor R3.

The comparator 251 may generate a container recognition signal (RS_cou) in an interval in which the resonant signal exceeds the reference voltage (refer to a comparator output signal 770 of FIG. 7). The container recognition signal (RS_cou) may be a square wave. The number of square waves generated by the comparator 251 may be determined by the number of sine waves input as the resonant signal that exceed the reference voltage. The time interval in which the square wave is output by the comparator 251 may be a time duration during which the resonant signal exists. The amplitude of the resonant signal may gradually decrease over time. For example, the primary container recognition operation may utilize the difference between the first resonant signal generated by the resonant circuit 260 in case that the container 20 is placed on the heating areas 111, 113 and/or 115 and the second resonant signal generated by the resonant circuit 260 in case that no container 20 is placed on the heating areas 111, 113 and/or 115. For example, as time elapses, the speed at which the amplitude of the first resonant signal decreases may be relatively faster than the speed at which the amplitude of the second resonant signal decreases. This is because a resistance component due to the container 20 placed on the heating areas 111, 113 and/or 115 may affect the resonant circuit 260. Therefore, in case that the second resonant signal is input, the comparator 251 may output a square wave for a shorter interval compared to in case that the first resonant signal is input. This shortened interval may imply that the number of square waves output from the comparator 251 is relatively less.

The container recognition signal (RS_cou) output from the comparator 251 may be provided to the controller 210. The controller 210 may recognize whether the container 20 is placed on the heating areas 111, 113 and/or 115 based on the container recognition signal (RS_cou) provided from the comparator 251. As an example, the controller 210 may count the number of square waves and determine whether the container 20 is placed on the heating areas 111, 113 and/or 115 based on whether the count value reaches a reference value. For instance, in case that the count value reaches or exceeds the reference value, the controller 210 may determine that the container 20 is not placed on the heating areas 111, 113 and/or 115. For instance, in case that the count value does not reach the reference value, the controller 210 may determine that the container 20 is placed on the heating areas 111, 113 and/or 115.

The comparator 251 may further include a capacitor at its output terminal. The capacitor may be charged with a voltage based on the container recognition signal (RS_cou) output by the comparator 251. In such a case, the controller 210 can recognize whether the container 20 is placed on the heating areas 111, 113 and/or 115, based on the voltage level charged on the capacitor. As an example, the controller 210 may determine whether the container 20 is placed on the heating areas 111, 113 and/or 115, based on whether the charged voltage level reaches a reference voltage level. For instance, if the charged voltage level reaches or exceeds the reference voltage value, the controller 210 may determine that the container 20 is not placed on the heating areas 111, 113 and/or 115. For instance, in case that the charged voltage level does not reach the reference voltage level, the controller 210 may determine that the container 20 is placed on the heating areas 111, 113 and/or 115.

Upon recognizing that the container 20 is placed on the first working coil 245 by the container recognition signal (RS_cou), and in response to an event requesting the heating of the container 20, the controller 210 may output a third switching control signal (C.S3) and/or a fourth switching control signal (C.S4) to control the relay unit 230 to switch from the first connection state (in FIG. 5) to the second connection state (in FIG. 6). In such a case, since the resonant signal for the primary container recognition operation is no longer required, the controller 210 may not output the fifth switching control signal (C.S5) to control the fifth switch element SW5 (253).

In case that an event requesting the heating of the container 20 occurs, the controller 210 may perform the control for the secondary container recognition operation and/or the heating operation. The secondary container recognition operation may be a container recognition operation in the post-power supply state. In the post-power supply state, power may be supplied to the working coil (W.C 245) for heating the one or more heating areas 111, 113 and/or 115. In this case, a current flow may be created in the working coil (W.C 245) due to the supplied power. The current flow causes the working coil (W.C 245) to generate an electromagnetic field. The electromagnetic field may be used to heat the container 20 placed on the heating areas 111, 113 and/or 115.

During the secondary container recognition operation, the controller 210 may use the amount of current measured by the current transformer 280 arranged on the path where current flows due to the power supply. In the current flowing path, the amount of current measured in case where the container 20 is placed on the heating areas 111, 113 and/or 115 may be different from the amount of current measured in case where the container 20 is not placed. For example, the amount of current measured in case where the container 20 is placed may be relatively less than the amount of current measured in case where the container 20 is not placed. It is because a resistance component due to the container 20 placed on the heating areas 111, 113 and/or 115 may affect the current flow.

Upon recognizing that the container 20 is placed on the heating areas 111, 113 and/or 115 by the primary container recognition operation and then switching to the post-power supply state, or upon recognizing that the container 20 is placed on the heating areas 111, 113 and/or 115 by the secondary container recognition operation in the post-power supply state, the controller 210 may output a first switch control signal C.S1 and/or a second switch control signal (C.S2) to control the first switch element SW1 (271) and/or the second switch element SW2 (273) included in the power supply switch unit 270 so as to generate an electromagnetic field in the heating areas 111, 113 and/or 115 where the container 20 is placed. The controller 210 may alternately output the first switch control signal C.S1 that turns-on the first switch element SW1 (271) and the second switch control signal (C.S2) that turns-on the second switch element SW2 (273). It may cause the flow of current supplied to the cooking coil 245 to be periodically changed. In the turn-on state of the first switch element SW1 (271), a current flow caused by the power supplied by the power supply unit 220 may occur. In the turn-on state of the second switch element SW2 (273), a current flow caused by the power supplied by the charging unit C4 or C5 may occur.

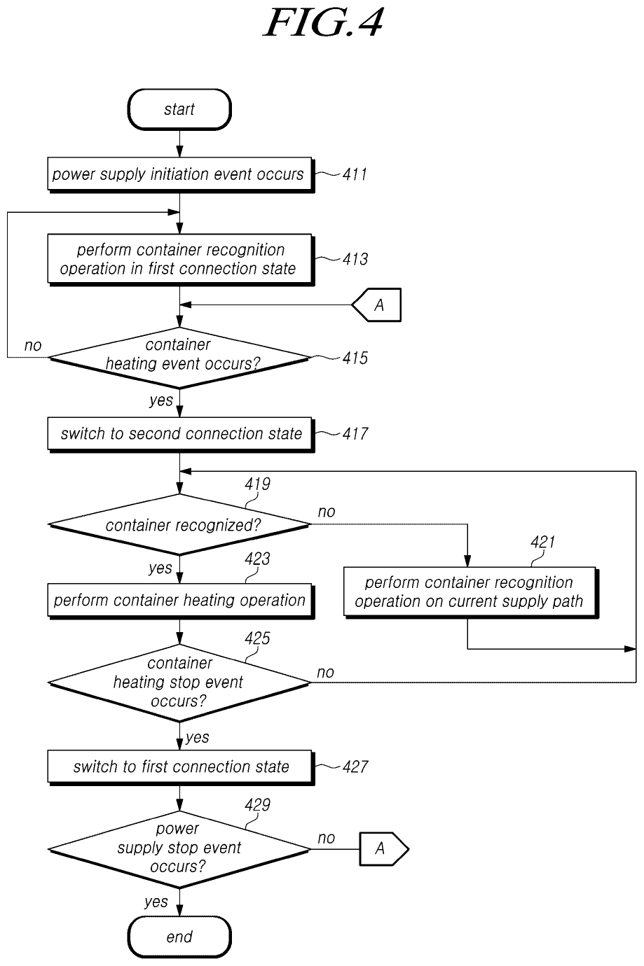

FIG. 4 illustrates a control flow for performing a heating operation based on container recognition in an induction heating device (e.g., the induction heating device 10 of FIG. 1) according to an embodiment of the disclosure.

Referring to FIG. 4, the induction heating device 10, in operation 411, may obtain the occurrence of a power supply initiation event. The power supply initiation event may occur in case that the power of the induction heating device 10 is turned on. As an example, the induction heating device 10 may recognize turning-on of the power by a power plug being inserted into a power outlet. As an example, the induction heating device 10 may recognize turning-on of the power by the power button being turned on while the power plug is inserted into the power outlet.

In case that the power supply initiation event occurs, the induction heating device 10, in operation 413, may perform a primary container recognition operation in the first connection state. According to an example, the induction heating device 10, in the first connection state, does not supply power to the working coil (W.C 245) for heating one or more heating areas (e.g., the one or more heating areas 111, 113 and/or 115 of FIG. 1), and allows the voltage to be used during the heating operation to be charged to a charging capacitor (e.g., C3 or C4 of FIG. 3). The induction heating device 10, during the primary container recognition operation, may form a resonant circuit (e.g., the resonant circuit 260 of FIG. 2). For example, in the primary container recognition operation, the induction heating device 10 may operate an internal relay (e.g., the first relay 231 or the second relay 233 of FIG. 3) so that the resonant circuit 260 is formed. The induction heating device 10 may perform the primary container recognition operation based on the resonant signal (e.g., the resonant signal 760 of FIG. 7) generated by the resonant circuit 260. As an example, the induction heating device 10 may determine whether the container 20 is placed on the heating areas 111, 113 and/or 115 based on the speed at which the amplitude of the resonant signal 760 decreases over time.

The induction heating device 10, in operation 415, may monitor whether a container heating event occurs. The container heating event may be generated by manipulation of a control lever (e.g., a control lever 121, 123 or 125 of FIG. 1) corresponding to at least one heating area of the one or more heating areas 111, 113 and/or 115. In case that the container heating event has not occurred, the induction heating device 10 may continue to perform the primary container recognition operation.

In case that the container heating event occurs, the induction heating device 10, in operation 417, may switch to the second connection state to perform the secondary container recognition operation and/or the heating operation. As an example, the induction heating device 10 may switch from the first connection state to the second connection state by controlling an internal relay (e.g., the first relay 231 or the second relay 233 of FIG. 3). The second connection state may be a connection state in which a current flow caused by the current supplied by the power supply unit 220 or the current supplied by the charging unit (e.g., the fourth capacitor C4 or the fifth capacitor C5 of FIG. 3) is created.

The induction heating device 10, in operation 419, determines whether the container 20 was recognized as being placed on the heating areas 111, 113 and/or 115 during the primary container recognition operation. In case that the container 20 was already detected as being placed on the heating areas 111, 113 and/or 115 in the primary container recognition operation, the induction heating device 10, in operation 423, may perform the container heating operation. As an example, the container heating device 10 may form a path that allows the current supplied by the power supply unit 220 or the current supplied by the charging unit (e.g., the fourth capacitor C4 or the fifth capacitor C5 of FIG. 3) to flow through the cooking coil 245.

In case that the induction heating device 10 did not detect that the container 20 was placed on the heating areas 111, 113 and/or 115 in the primary container recognition operation, the induction heating device 10, in operation 421, may perform the secondary container recognition operation. The induction heating device 10 may determine whether the container 20 is placed on the heating areas 111, 113 and/or 115 using the amount of current measured by the current transformer (e.g., the current transformer 280 of FIG. 3) provided on a path of current flow by the power supply. As an example, in case that the amount of current measured by the current transformer 280 is lower than a reference current amount, the induction heating device 10 may determine that the container 20 is placed on the heating areas 111, 113 and/or 115. As an example, in case that the amount of current measured by the current transformer 280 is equal to or greater than the reference current amount, the induction heating device 10 may determine that the container 20 is not placed on the heating areas 111, 113 and/or 115. It is because a resistance component due to the container 20 placed on the heating areas 111, 113 and/or 115 may affect the current flow. The induction heating device 10, in operation 419, may determine whether the container 20 is placed on the heating areas 111, 113 and/or 115 through the secondary container recognition operation.

While the container heating operation is performed, the induction heating device 10, in operation 425, may monitor whether a container heating stop event occurs. The heating stop event may occur due to manipulation of the control lever (e.g., the control lever 121, 123 or 125 of FIG. 1) corresponding to at least one heating area of the one or more heating areas 111, 113 and/or 115. The heating stop event may occur due to removal of the container 20 placed on at least one heating area of the one or more heating areas 111, 113 and/or 115.

In case that the container heating stop event occurs, the induction heating device 10, in operation 427, may switch to the first connection state to perform the primary container recognition operation. As an example, the induction heating device 10 may switch from the second connection state to the first connection state by controlling the internal relay (e.g., the first relay 231 or the second relay 233 of FIG. 3). The first connection state may block the flow of the current supplied by the power supply unit 220 or the current supplied by the charging unit (e.g., the fourth capacitor C4 or the fifth capacitor C5), and form the resonant circuit 260 again.

In case of the induction heating device 10 switching to the first connection state, in operation 429, it may determine whether a power supply stop event occurs. The power supply stop event may occur by the power of the induction heating device 10 being turned off. For example, the induction heating device 10 may recognize that the power supply is cut off by the power plug being pulled out from the power outlet. For example, the induction heating device 10 may recognize that the power is turned off by the power button being turned off with the power plug being inserted into the power outlet.

In case the power supply stop event does not occur, the induction heating device 10, in operation 415, may determine whether a container heating event has occurred. In case where the container heating event has not occurred, the induction heating device 10, in operation 413, may perform the primary container recognition operation in the first connection state.

FIG. 5 illustrates a path activated for a primary container recognition operation in a driving circuit of an induction heating device (e.g., the induction heating device 10 of FIG. 1) according to an embodiment of the disclosure.

Referring to FIG. 5, during the primary container recognition operation, a first relay (e.g., the first relay 231) and a second relay (e.g., the second relay 233) included in the induction heating device 10 may operate in the normal state, which is the first connection state. In the first connection state, the first relay 231 may operate to open the connection between the power supply unit 220 and the heating unit 240, and short-circuit the connection between the sensing unit 250 and the heating unit 240. In the first connection state, the second relay 233 may operate to open the connection between the heating unit 240 and the charging unit, and short-circuit the connection between the sensing unit 250 and the heating unit 240. Thereby, the resonant circuit 260 in which the cooking coil 245 and the resonant capacitor C3 are connected in parallel may be formed. Furthermore, a path may be completed for inputting a reference voltage, which is a first input signal, and a resonant signal (generated by the resonant circuit 260), which is a second input signal, to the comparator 251.

As described above, the path activated during the primary container recognition operation in the driving circuit is shown by a bold solid line.

FIG. 6 illustrates the path activated for a secondary container heating operation in a driving circuit of an induction heating device according to an embodiment of the disclosure.

Referring to FIG. 6, during the secondary container recognition heating operation and/or the container heating operation, the first relay (e.g., the first relay 231) and the second relay (e.g., the second relay 233) included in the induction heating device 10 may operate in the second connection state. In the second connection state, the first relay 231 may operate to open the connection between the sensing unit 250 and the heating unit 240, and short-circuit the connection between the power supply unit 220 and the heating unit 240. In the second connection state, the second relay 233 may operate to open the connection between the sensing unit 250 and the heating unit 240, and short-circuit the connection between the charging unit and the heating unit 240. Thereby, a path allowing the current supplied by the power supply unit 220 or the current supplied by the charging unit (e.g., the fourth capacitor C4 or the fifth capacitor C5 of FIG. 3) to flow through the cooking coil 245 may be completed.

As described above, the path activated for the secondary container recognition operation and/or the container charging operation in the driving circuit is shown by a bold solid line.

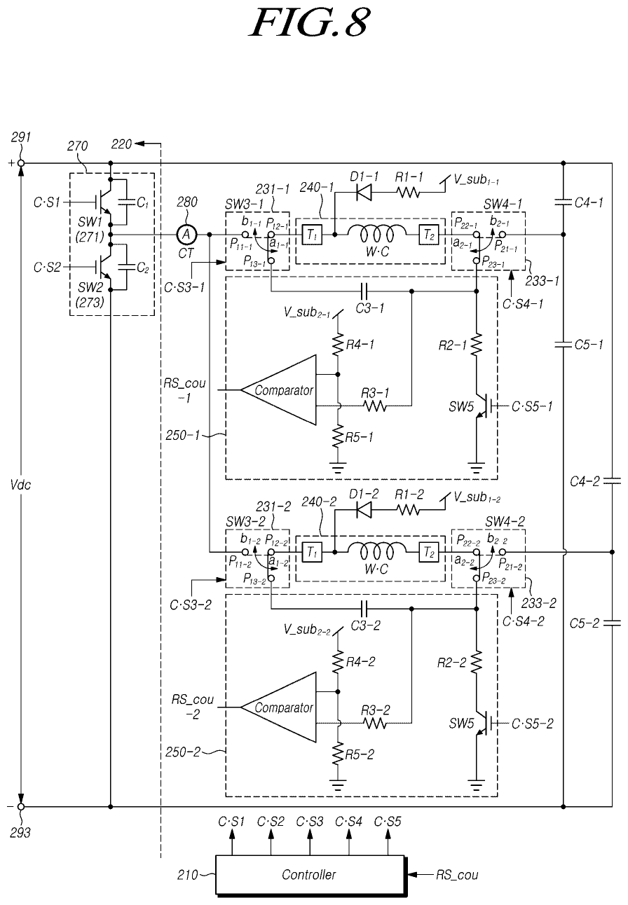

FIG. 8 illustrates a driving circuit in an induction heating device (e.g., the induction heating device 10 of FIG. 1) according to an embodiment of the disclosure.

The induction heating device 10 shown in FIG. 8 may include a plurality of driving circuits. Each of the plurality of driving circuits may have substantially the same structure as the driving circuit shown in FIG. 3. For example, each of the plurality of driving circuits may independently include first relays 231-1 and 231-2, heating units 240-1 and 240-2, sensing units 250-1 and 250-2, second relays 233-1 and 233-2, or a charging unit. The plurality of driving circuits may share a controller (e.g., the controller 210 of FIG. 2) or a power supply switch unit 270. The heating units 240-1 and 240-2 may include one or more heating circuits. The sensing units 250-1 and 250-2 may include one or more sensing circuits. The charging unit may include one or more charging capacitors.

The first relay 231-1 included in the first driving circuit of the plurality of driving circuits may be configured to selectively connect the first heating unit 240-1 to either the first sensing unit 250-1 or the power supply switch unit 270. The second relay 233-1 included in the first driving circuit may be configured to selectively connect the first heating unit 240-1 to either the first sensing unit 250-1 or the charging unit C4-1 or C5-1.

The first relay 231-2 included in the second driving circuit of the plurality of driving circuits may be configured to selectively connect the second heating unit 240-2 to either the second sensing unit 250-2 or the power supply switch unit 270. The second relay 233-2 included in the second driving circuit may be configured to selectively connect the first heating unit 240-2 to either the first sensing unit 250-2 or the charging unit C4-2 or C5-2.

The first relays 231-1 and 231-2, the heating units 240-1 and 240-2, the sensing units 250-1 and 250-2, and the second relays 233-1 and 233-2 included in each of the plurality of driving circuits shown in FIG. 8 may have substantially the same structure as the first relay 231, the heating unit 240, the sensing unit 250, and the second relay 233 shown in FIG. 3. Therefore, a detailed description of the structure of the first relays 231-1 and 231-2, the heating units 240-1 and 240-2, the sensing units 250-1 and 250-2, and the second relays 233-1 and 233-2 shown in FIG. 8 will not be reiterated.

According to an embodiment of the disclosure, an induction heating device 10 may include a display 140, a power supply circuit 220 for supplying power, a first heating circuit 240 including a first working coil 245 that generates a magnetic field in response to a current flow caused by power supply of the power supply circuit 220, a first sensing circuit 250 including a first resonant capacitor C3 connected in parallel with the first working coil 245 to form a resonant circuit 260, and outputting a first container recognition signal (RS_cou) 770 using a resonant signal 760 generated by the resonant circuit 260 and a reference voltage value, and a first relay circuit 230 that selectively operates in one of a first connection state (FIG. 5) in which the first working coil 245 and the first resonant capacitor C3 are connected in parallel, or a second connection state (FIG. 6) in which a current flow caused by the power supply of the power supply circuit 220 is formed in the first working coil 245.

According to an embodiment of the disclosure, the induction heating device 10 may include a controller 210 recognizing that a container 20 is placed on the first working coil 245 by the first container recognition signal (RS_cou) and controlling the display 140 to display a message indicating that the container 20 is placed on the first working coil 245.

According to an embodiment of the disclosure, the controller 210 may control the first relay circuit 230 to switch from the first connection state (FIG. 5) to the second connection state (FIG. 6), in response to an event requesting heating of the container 20, and control the first relay circuit 230 to switch from the second connection state (FIG. 6) to the first connection state (FIG. 5), in response to an event requesting stop of heating the container 20.

According to an embodiment of the disclosure, wherein the first sensing circuit 250 may include a switch element (SW5) 253 that, in response to the control of the controller 210, connects the first working coil 245 and the first resonant capacitor C3 in parallel in the first connection state (FIG. 5) to perform switching between any point of a closed loop forming the resonant circuit 260 and a ground terminal at a predetermined period.

According to an embodiment of the disclosure, the predetermined period may be determined by a time interval during which the resonant signal 760 is generated by the resonant circuit 260.

According to an embodiment of the disclosure, the first sensing circuit 250 may include a comparator 251 which takes the resonant signal 760 and the reference voltage value as inputs, and outputs a pulse signal 770 corresponding to a result of comparison between the resonant signal 760 and the reference voltage value as the first container recognition signal (RS_cou).

According to an embodiment of the disclosure, the first sensing circuit 250 may include a comparator 251 which takes the resonant signal 760 and the reference voltage value as inputs and outputs a pulse signal 770 corresponding to a result of comparison between the resonant signal 760 and the reference voltage value, and a capacitor charged by the pulse signal 770 output from the comparator 251.

According to an embodiment of the disclosure, a voltage value charged on the capacitor may be provided to the controller 210 as the first container recognition signal (RS_cou).

According to an embodiment of the disclosure, the first heating circuit 240 may include a supply terminal for supplying an auxiliary voltage (V_sub1) for generating the resonant signal 760 at any point between the first relay circuit 230 and the first working coil 245 in closed loop forming the resonant circuit 260.

According to an embodiment of the disclosure, the first relay circuit 230 may include switch elements 231 and 233 that are switched from the first connection state (FIG. 5) to the second connection state (FIG. 6) in response to the control of the controller 210, and in case that there is no control from the controller 210 or during an initial operation in response to an event initiating the power supply of the power supply circuit 220, maintain the first connection state (FIG. 5) or switching from the second connection state (FIG. 6) to the first connection state (FIG. 5).

According to an embodiment of the disclosure, the first relay circuit 230 may include a first relay 231 configured to switch one end of the first working coil 245 to one of the first resonant capacitor C3 or the power supply circuit 220, and a second relay 233 configured to switch the other end of the first working coil 245 to one of the first resonant capacitor C3 or a charging capacitor C4 or C5.

According to an embodiment of the disclosure, the induction heating device 10 may include a current transformer CT 280 configured to measure an amount of current on a path corresponding to the current flow caused by the power supply of the power supply circuit 220 in the second connection state (FIG. 6).

According to an embodiment of the disclosure, the controller 210 may be configured to recognize that the container 20 is placed on the first working coil 245 by considering a change in the amount of current measured through the current transformer 280.

According to an embodiment of the disclosure, the induction heating device 10 may include first switching elements (SW1) 271 and second switching element (SW2) 273 that are connected in series between the terminals 291 and 293 supplied with power from the power supply circuit 220, and the current transformer 280 may be arranged on a path connecting a location between the first switching element (SW1) 271 and second switching element (SW2) 273 and the first relay circuit 230.

According to an embodiment of the disclosure, the induction heating device 10 may include first switching element (SW1) 271 and second switching element (SW2) 273 that are connected in series between the terminals 291 and 293) supplied with power from the power supply circuit 220, and first and second charging capacitors C4 and C5 connected in parallel with the first switching element (SW1) 271 and second switching element (SW2) 273 between the terminals 291 and 293 supplied with power from the power supply circuit 220.

According to an embodiment of the disclosure, the first relay circuit 230 may include a relay 231 operating to switch the first working coil 245 to one of the first resonant capacitor C3 or any one position between the first switching element (SW1) 271 and second switching element (SW2) 273.

According to an embodiment of the disclosure, the controller 210 may control the first switching element (SW1) 271 and the second switching element (SW2) 273 to be alternately switched in the second connection state (FIG. 6).

According to an embodiment of the disclosure, the induction heating device 10 may include one or more second heating units 240-2 connected in parallel with the first heating circuit 240-1, one or more second sensing circuits 250-2 outputting a second container recognition signal (RS_cou #2) corresponding to the second working coil 245-2 included in the one or more second heating units 240-2, and a second relay circuit 230-2 that selectively operates in one of a third connection state in which the second working coil 245-2 and a second resonant capacitor C3-2 included in the one or more second sensing circuits 250-2 are connected in parallel, or a fourth connection state in which a current flow caused by the power supply of the power supply circuit 220 is formed by the second working coil 245-2.

According to an embodiment of the disclosure, an amplitude attenuation of the resonant signal 760 occurs relatively faster in case that the container 20 is placed on the first working coil 245 compared to in case that the container 20 is not placed thereon.

According to an embodiment of the disclosure, the first container recognition signal (RS_cou) may include a relatively larger number of pulses in case that the container 20 is not placed on the first working coil 245 compared to in case that the container 20 is placed thereon.

According to an embodiment of the disclosure, the first container recognition signal (RS_cou) may have a relatively higher voltage value charged in the capacitor in case that the container 20 is not placed on the first working coil 245 compared to in case that the container 20 is placed thereon.

According to an embodiment of the disclosure, a container recognition circuit included in the induction heating device 10 may include a resonant capacitor C3, a working coil 245 that generates a magnetic field by the supplied power, and a relay circuit 230 operating so that the working coil 245 and the resonant capacitor C3 are connected in parallel until a container heating event occurs.

According to an embodiment of the disclosure, a terminal for supplying an auxiliary power source (V_sub1) may be provided at any point of the resonant circuit 260 that may be configured by a limited parallel connection of the working coil 245 and the resonant capacitor C3.

According to an embodiment of the disclosure, the relay circuit 230 may include a first relay 231 configured to connect one end of the working coil 245 to one of the resonant capacitor C3 or the power supply circuit 220, and a second relay 233 configured to connect the other end of the working coil 245 to one of the resonant capacitor C3 or the charging capacitor C4 or C5.

According to an embodiment of the disclosure, the induction heating device 10 may include a switch element (SW5) 253 that switches any point of the closed loop forming the resonant circuit 260 and a ground terminal at a predetermined period, wherein the predetermined period may be determined by a time interval during which the resonant signal 760 is generated by the resonant circuit 260.

According to an embodiment of the disclosure, the induction heating device 10 may include a comparator 251 that outputs a signal 770 corresponding to a result of comparison between a first input, which the resonant signal 760 generated by the resonant circuit 260 is applied by a switching operation of the switch element (SW5) 253, and a second input, which is a voltage divided by a predetermined resistance ratio, as the container recognition signal (RS_cou).

According to an embodiment of the disclosure, the controller 210 may be further configured to control the first switching element (SW1) 271 and the second switching element (SW2) 273 to be alternately switched in the second connection state.

According to an embodiment of the disclosure, the induction heating device 10 further comprises one or more second heating units connected in parallel with the first heating circuit; one or more second sensing circuits configured to output a second container recognition signal corresponding to a second working coil included in the one or more second heating units; and a second relay circuit selectively operable in one of: a third connection state in which the second working coil and a second resonant capacitor included in the one or more second sensing circuits are connected in parallel; or a fourth connection state in which a current flow caused by a power supply of the power supply circuit is formed through the second working coil.

An electronic device according to various embodiments disclosed herein may be various types of apparatuses. The electronic device may include, for example, kitchen appliance such as a heating device for cooking (e.g., an induction range). The electronic device according to embodiments of the document is not limited to the aforementioned devices.

It should be appreciated that various embodiments of the disclosure and the terms used therein are not intended to limit the technological features set forth herein to particular embodiments and include various changes, equivalents, or replacements for a corresponding embodiment. As used in the disclosure, the term “and/or” is to be understood to encompass all possible combinations of one or more of the enumerated items. As used in the disclosure, the terms “comprise”, “have”, “include”, “consist of”, and the like are intended only to designate the presence of features, components, parts, or combinations thereof described in the disclosure, and the use of such terms is not intended to exclude the possibility of presence or addition of one or more other features, components, parts, or combinations thereof. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st”, “2nd”, or “first” or “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled” or “connected” with/to another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic”, “logic block”, “part”, or “circuit”. Such a “module” may be a single integral component, or a minimum unit or a part of the component, adapted to perform one or more functions. For example, according to an embodiment, the module may be implemented in the form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An induction heating device comprising:
a display;
a power supply circuit configured to supply power;
a first heating circuit including a first working coil configured to generate a magnetic field in response to a current flow caused by power supply of the power supply circuit;
a first sensing circuit including a first resonant capacitor connected in parallel with the first working coil to form a resonant circuit, and configured to output a first container recognition signal using a resonant signal generated by the resonant circuit and a reference voltage value;
a first relay circuit configured to selectively operate in one of a first connection state in which the first working coil and the first resonant capacitor are connected in parallel, or a second connection state in which a current flow caused by the power supply of the power supply circuit is formed in the first working coil; and
a controller configured to:
recognize that a container is placed on the first working coil by the first container recognition signal, and
control the display to display a message indicating that the container is placed on the first working coil.

2. The induction heating device of claim 1, wherein the controller is further configured to:
control the first relay circuit to switch from the first connection state to the second connection state, in response to an event requesting heating of the container; and
control the first relay circuit to switch from the second connection state to the first connection state, in response to an event requesting stop of heating the container.

3. The induction heating device of claim 1,
wherein the first sensing circuit includes a switch element configured to, in response to the control of the controller, connect the first working coil and the first resonant capacitor in parallel in the first connection state (to perform switching between any point of a closed loop forming the resonant circuit and a ground terminal at a predetermined period, and
wherein the predetermined period is determined by a time interval during which the resonant signal is generated by the resonant circuit.

4. The induction heating device of claim 1, wherein the first sensing circuit includes a comparator which takes the resonant signal and the reference voltage value as inputs, and is configured to output a pulse signal corresponding to a result of comparison between the resonant signal and the reference voltage value as the first container recognition signal.

5. The induction heating device of claim 1,
wherein the first sensing circuit includes:
a comparator which takes the resonant signal and the reference voltage value as inputs and is configured to output a pulse signal corresponding to a result of comparison between the resonant signal and the reference voltage value, and
a capacitor charged by the pulse signal output from the comparator,
wherein a voltage value charged on the capacitor is provided to the controller as the first container recognition signal, and
wherein for the first container recognition signal, a voltage value charged on the capacitor in case that the container is not placed on the first working coil is relatively higher compared to that in case that the container is placed thereon.

6. The induction heating device of claim 1, further comprising a supply terminal configured to supply an auxiliary voltage for generating the resonant signal at any point between the first relay circuit and the first working coil in closed loop forming the resonant circuit.

7. The induction heating device of claim 1, wherein the first relay circuit comprises switch elements configured to:
switch from the first connection state to the second connection state in response to the control of the controller, and
in case that there is no control from the controller or during an initial operation in response to an event initiating the power supply of the power supply circuit, maintain the first connection state or switch from the second connection state to the first connection state.

8. The induction heating device of claim 1, wherein the first relay circuit comprises:
a first relay configured to switch one end of the first working coil to one of the first resonant capacitor or the power supply circuit; and
a second relay configured to switch the other end of the first working coil to one of the first resonant capacitor or a charging capacitor.

9. The induction heating device of claim 1, further comprising:
a current transformer configured to measure an amount of current on a path corresponding to the current flow caused by the power supply of the power supply circuit in the second connection state,
wherein the controller is further configured to recognize that the container is placed on the first working coil by considering a change in the amount of current measured through the current transformer.

10. The induction heating device of claim 9, further comprising:
first and second switching elements that are connected in series between terminals supplied with power from the power supply circuit,
wherein the current transformer is arranged on a path connecting a location between the first and second switching elements and the first relay circuit.

11. The induction heating device of claim 1, further comprising:
first and second switching elements that are connected in series between terminals supplied with power from the power supply circuit; and
first and second charging capacitors connected in parallel with the first and second switching elements between the terminals supplied with power from the power supply circuit,
wherein the first relay circuit comprises a relay operating to switch the first working coil to one of the first resonant capacitor or any one position between the first and second switching elements.

12. The induction heating device of claim 10, wherein the controller is further configured to control the first switching element and the second switching element to be alternately switched in the second connection state.

13. The induction heating device of claim 1, further comprising:
one or more second heating units connected in parallel with the first heating circuit;
one or more second sensing circuits configured to output a second container recognition signal corresponding to the second working coil included in the one or more second heating units; and
a second relay circuit that selectively operates in one of a third connection state in which the second working coil and a second resonant capacitor included in the one or more second sensing circuits are connected in parallel, or a fourth connection state in which a current flow caused by the power supply of the power supply circuit is formed by the second working coil.

14. The induction heating device of claim 1, wherein an amplitude attenuation of the resonant signal occurs relatively faster in case that the container is placed on the first working coil compared to in case that the container is not placed thereon.

15. The induction heating device of claim 1, wherein the first container recognition signal includes a relatively larger number of pulses in case that the container is not placed on the first working coil compared to in case that the container is placed thereon.

16. The induction heating device of claim 11, wherein the controller is further configured to control the first switching element the second switching element to be alternately switched in the second connection state.

17. The induction heating device of claim 12, further comprising:
one or more second heating units connected in parallel with the first heating circuit;
one or more second sensing circuits configured to output a second container recognition signal corresponding to the second working coil included in the one or more second heating units; and
a second relay circuit that selectively operates in one of a third connection state in which the second working coil and a second resonant capacitor included in the one or more second sensing circuits are connected in parallel, or a fourth connection state in which a current flow caused by the power supply of the power supply circuit is formed by the second working coil.
